(19) United States
(12) Patent Application Publication
(10) Pub. No.: US 2010/0224737 A1
(43) Pub. Date: Sep. 9, 2010

(54) Adjustable Cable Management Bar And System

(75) Inventors: Gregg LaFontaine, Lebanon, CT (US); Lars R. Larsen, Old Lyme, CT (US); William H. Dietz, Branford, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: Ortronics, Inc., New London, CT (US)

(21) Appl. No.: 12/399,776

(22) Filed: Mar. 6, 2009

(51) Int. Cl. F16L 3/08

(52) U.S. Cl. 248/70; 248/65

(57) ABSTRACT

Apparatus, systems and methods are provided for facilitating cable management. More particularly, an adjustable cable management bar is provided including a plurality of mounting brackets, a plurality of fasteners and a support member having a plurality of mounting flanges for translational association with said mounting brackets by means of said fasteners. Thus, the mounting brackets may be used to secure the support member in an adjustable arrangement relative to a patch panel. The cable management bar may be coupled with one or more swiveling cable management clips each clip including a top element, defining a channel for receipt of patch cables, a bottom element, having a clasp mechanism for effecting a translationaly relationship with the cable management bar and a shaft for rotationally relating the top element relative to the bottom element. Thus, a user may adjust the position and/or orientation of the clip to direct the patch cables as desired.

### BACKGROUND

1. Technical Field

The present disclosure relates to apparatus, systems and methods for cable management. More particularly, the present disclosure relates to apparatus, systems and methods for managing patch cables associated with patch panels or patching systems.

2. Background Art

Patch panels and systems are often used to facilitate networking between switches, servers, storage devices, etc. Patching allows a user to establish temporary and/or easily modified electrical connections between communication channels, thereby permitting rapid and efficient configuration and/or modification to network connections from a central location. To effect quick and efficient patching, patch panels and systems require efficient management of a large number of densely arrayed patch cables. Furthermore, the evolution toward transmitting high speed data over UTP (Unshielded Twisted Pair) cables has created the need for specialized termination practices. More particularly, apparatus and systems effecting cable management should comply with the EIA/TIA 568 Standard (for example, the bend radius for a patch cable should be no less than 4 times the cable's outer diameter, etc.). Thus, a patch system may advantageously include a cable management bar, e.g., a “Cable Management Support Bar” (Ortronics™ Product No.: OR-60400046; New London, CT), for grouping, arranging and routing patch cables relative thereto, e.g., in accordance with applicable routing standards.

Referring now to FIGS. 1A and 1B, a cut-section of a prior art patching system is depicted, wherein a conventional cable management bar 5 is secured relative to a cabinet enclosure housing a plurality of patch panels. Referring now in particular to FIG. 1B, the cable management bar 5 is depicted, wherein patch cables, extending from the patch panels, are grouped, arranged and routed relative to the cable management bar 5 using tie wraps. Conventional cable management bars, however, may hinder access to the patch panels and cannot be easily adjusted for different cables and/or cable configurations.

Thus, apparatus, systems and methods are needed that allow unobstructed access to the patch panels, e.g., for modification purposes, while providing support for the cables thereafter. Moreover, a need exists for adjustable support means for grouping, arranging and routing patch cables relative thereto. These and other needs are addressed by the apparatus, systems and methods of the present disclosure.

### SUMMARY

The apparatus, systems and methods disclosed herein generally involve an adjustable cable management bar for grouping, arranging and routing cables, e.g., patch cables, relative to an associated structure. In exemplary embodiments, the cable management bar includes a plurality of mounting brackets and a support member having a plurality of mounting flanges for association with a proximal end of respective mounting brackets. The support member may be translationally/removably related relative to the plurality of mounting brackets. A distal end of the mounting brackets may include a mounting surface for securing said brackets, e.g., relative to a cabinet enclosure housing one or more patch panels. Thus, the mounting brackets may be used to secure the support member in an optimal arrangement relative to the one or more patch panels, wherein the position of the support member may be adjusted by means of the translational relationship between the mounting brackets and mounting flanges. The support member may be secured in said optimal arrangement by means of one or more securing members, e.g., fasteners.

In further exemplary embodiments, the support member may be detached from the mounting brackets and removed completely. By removing the support member completely, a user may obtain unobstructed access to the one or more patch panels therebehind. Thus, the user may make any necessary cabling changes relative to the patch panels without having to work around the cable management bar. Once the user has finished making changes, the support member can easily be reattached relative to the mounting brackets. The position of the support member may then be readjusted to a new optimal arrangement (reflecting said changes to the patch panels) and the support member optionally secured in the new optimal arrangement by means of the fasteners.

A swiveling cable management clip for association with a cable management bar is also disclosed according to the present disclosure. The cable management clip generally includes a top element, defining a channel for receipt of one or more patch cables, and a bottom element, having a clasp mechanism for securing said cable management clip relative to the cable management bar. The top element is generally rotationally related relative to the bottom element by means of a shaft. In exemplary embodiments, the bottom face of the top element may define notches corresponding to teeth defined in the top face of the bottom element. Thus, when the top element contacts the bottom element, the notches and teeth cooperate to prevent the top element from rotating relative to the bottom element, thereby defining a detent mechanism. In alternative exemplary embodiments, a ratchet configuration may be employed to prevent rotation in a single direction.

In exemplary embodiments of the present disclosure, a cable management bar may be coupled with one or more swiveling cable management clips. Each cable management clip may be attached relative to the support member of the cable management bar by means of the clasp mechanism included on the bottom element of the cable management clip. The cable management clips may be translationaly related relative to the support member of the cable management bar. Thus, a user may slide the cable management clips along the length of the support member and/or swivel the clips to effect a preferred position/orientation thereof. The cable management clips may be used to advantageously group and direct patch cables while promoting a desirable bend radius thereof.

The present disclosure further encompasses an advantageous method for facilitating cable management wherein an adjustable cable management bar is provided that includes (i) a plurality of mounting brackets, mounted relative one or more patch panels; and (ii) a cable support member detachably associated relative to the mounting brackets and obstructing or partially obstructing access to the one or more patch panels. The method further entails detaching the adjustable cable management bar from the mounting brackets and removing the cable management bar, such that the cable management bar ceases to obstruct or partially obstruct access to the one or more patch panels, making any desired cabling changes relative to the one or more patch panels, and reattaching the support member relative to the mounting brackets after the any desired cabling changes are complete.

Additional features, functions and benefits of the disclosed apparatus, systems and methods will be apparent from the description which follows, particularly when read in conjunction with the appended figures.

### BRIEF DESCRIPTION OF THE DRAWINGS

To assist those of ordinary skill in the art in making and using the disclosed apparatus, systems and methods, reference is made to the appended figures, wherein:

FIG. 1A (Prior Art) is a perspective cut-section view of a patching system having a conventional, non-adjustable cable management bar.

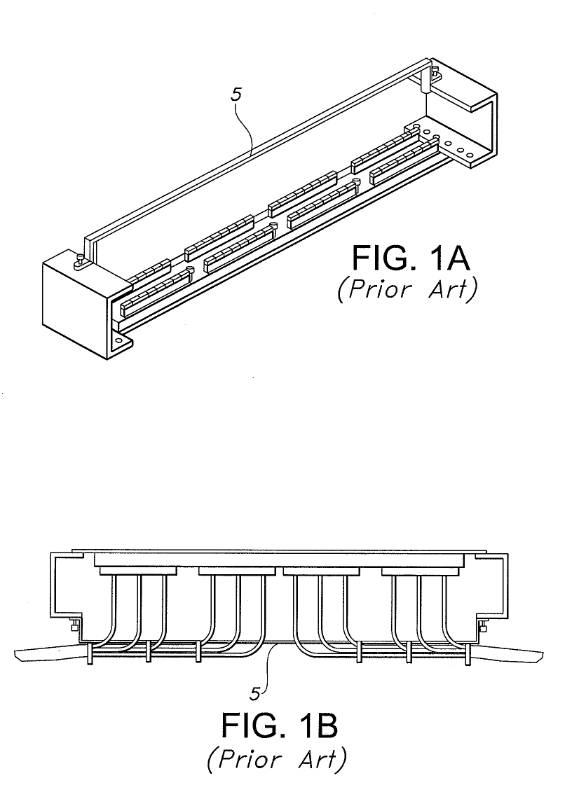

FIG. 1B (Prior Art) is a top view of the cut-section of FIG. 1A, wherein patch cables are depicted grouped, arranged and routed relative to the conventional cable management bar.

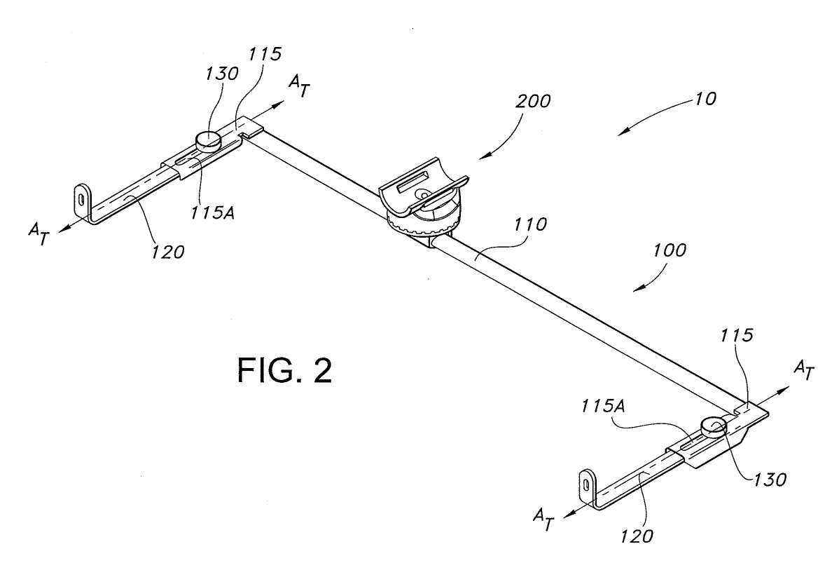

FIG. 2 is a perspective view of an exemplary cable management assembly according to the present disclosure, the cable management assembly having an adjustable cable management bar and a swiveling cable management clip.

FIG. 3 is an exploded view of the exemplary cable management assembly in FIG. 2 FIG. 4 is an enlarged perspective view of a mounting bracket shown in FIGS. 2 and 3.

FIG. 5 is an enlarged bottom view a mounting flange shown in FIGS. 2 and 3, FIG. 6 is an enlarged bottom view of the mounting flange shown in FIG. 5 in association with a mounting bracket, e.g., the mounting bracket of FIG. 4.

FIGS. 7 and 8 are enlarged top and bottom views, respectively, of the mounting flange and mounting bracket of FIG. 6 in further association with a fastener.

FIG. 9 is an exploded perspective view of the swiveling cable management clip of FIGS. 2 and 3.

### DESCRIPTION OF EXEMPLARY EMBODIMENT(S)

According to the present disclosure, advantageous apparatus, systems and methods are provided for facilitating cable management. More particularly, the disclosed apparatus, systems and methods generally include an adjustable cable management bar 100 for grouping, arranging and routing cables, e.g., patch cables, relative to an associated structure. An advantageous swiveling cable management clip 200 for association with said cable management bar 100 is also disclosed herein.

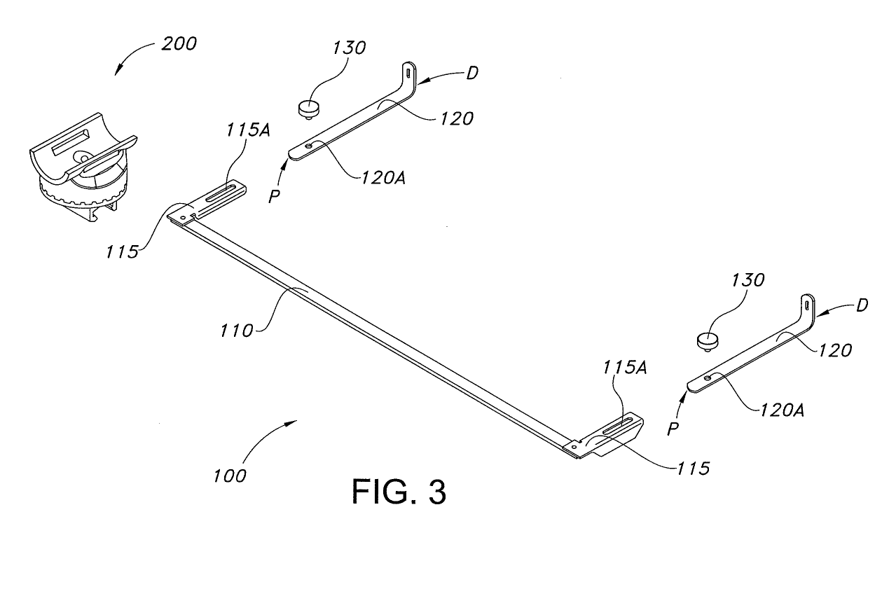

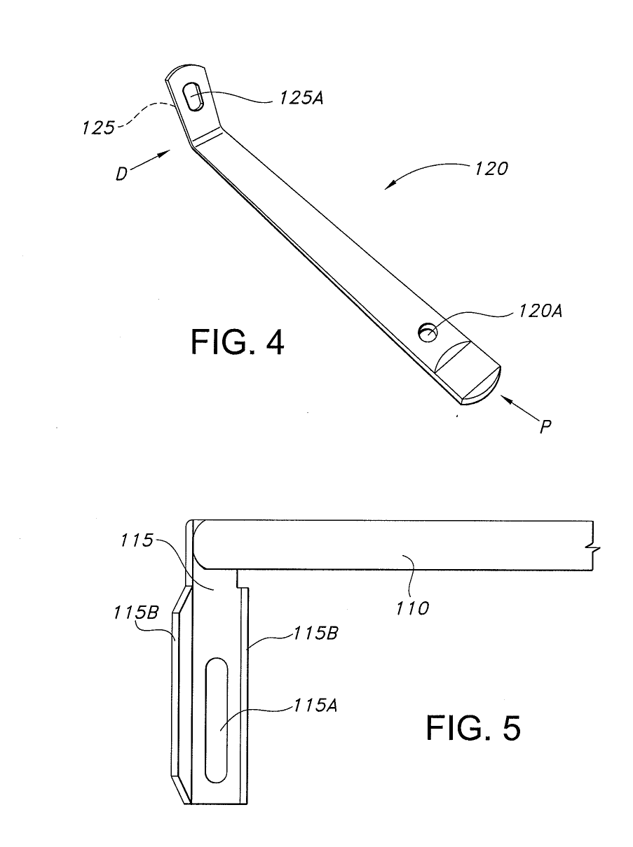

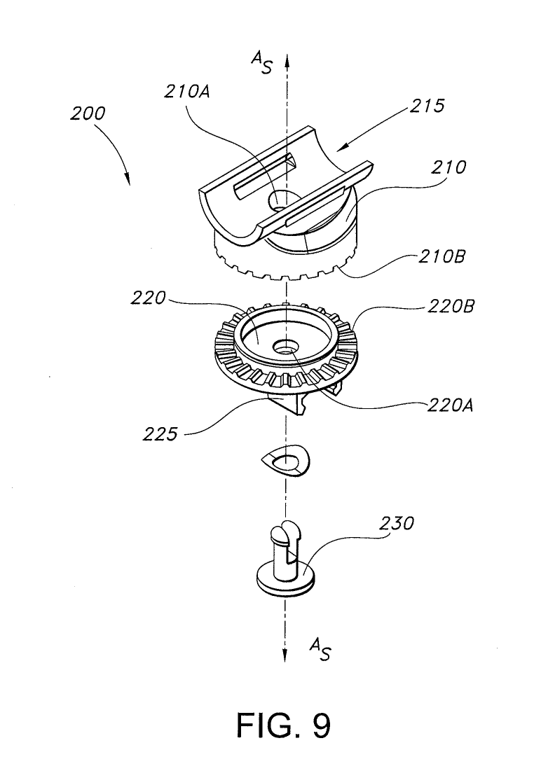

With initial reference to FIGS. 2 and 3, an exemplary cable management assembly 10 is depicted. The cable management assembly 10 generally includes a cable management bar 100 and a cable management clip 200. Note that the cable management clip 200 is later described in greater detail with reference to FIG. 9. Referring still to FIGS. 2 and 3, the cable management bar 100 typically includes a support member 110, a plurality of mounting brackets 120, and a plurality of fasteners, e.g., screws 130. In exemplary embodiments, the support member 110 includes a plurality of mounting flanges 115 extending perpendicularly from the ends of the support member 110. Each mounting flange 115 is typically configured and dimensioned for association with a proximal end “P” of a corresponding mounting bracket 120. Thus, each mounting flange 115 may define a grooved region for receipt of the proximal end “P” of the corresponding mounting bracket 120, therein.

In exemplary embodiments, the support member 110 and brackets 120 are translationally related relative to one another along translation axes “A_{T}”. Each mounting flange 115 may therefore define a slot 115A for association with a hole 120A defined in the proximal end “P” of the corresponding mounting bracket 120. Each hole 120A may advantageously be threaded for association with one of the screws 130. Thus, in exemplary embodiments, the screws 130 may be inserted through the slots 115A and received within the holes 120A in mounting brackets 120. The screws 130 are generally able to slide along the slots 115A, thereby effecting the translational relationship between the support member 110 and the mounting brackets 120. In exemplary embodiments, the screws 130 may be loosened to effect said translational relationship or tightened to secure the support member 110 relative to the mounting brackets 120. In further exemplary embodiments, the screws 130 may be removed to detach the support member 110 from the mounting brackets 120. Generally, the support member 110 may be detached without having to first translate the support member relative to the mounting brackets 120. Thus, the support member may be detached or reattached in various configurations relative to the mounting brackets 120.

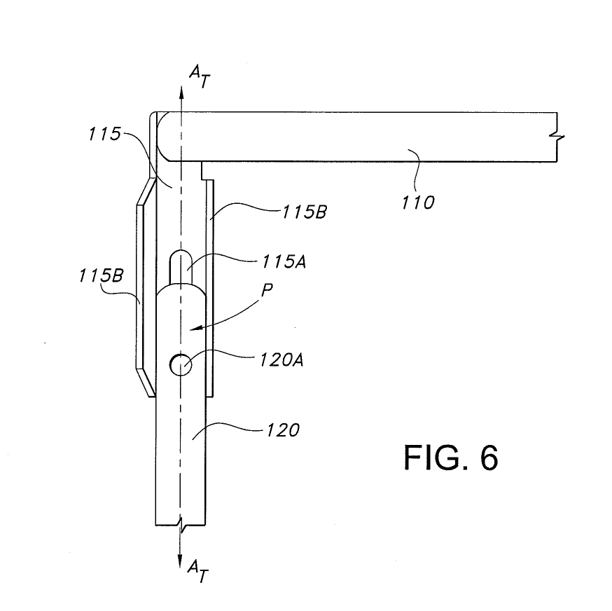

Referring now specifically to FIGS. 4 and 5, one of the mounting brackets 120 and a first end of the support member 110 are depicted, respectively. The mounting bracket 120 is generally “L”-shaped, defining a mounting surface 125 at a distal end “D” of the mounting bracket 120. The mounting surface 125 may define one or more apertures, such as aperture 125A, for securing/bolting the mounting bracket 120 relative to a cabinet enclosure, e.g., a patching system enclosure. The proximal end “P” of the mounting bracket 120 is typically configured and dimensioned for association with a corresponding mounting flange 115 of the support member 110. More particularly, the mounting flange 115 may include side walls 115B defining a grooved region for receipt of the proximal end “P” of the mounting bracket 120 therein.

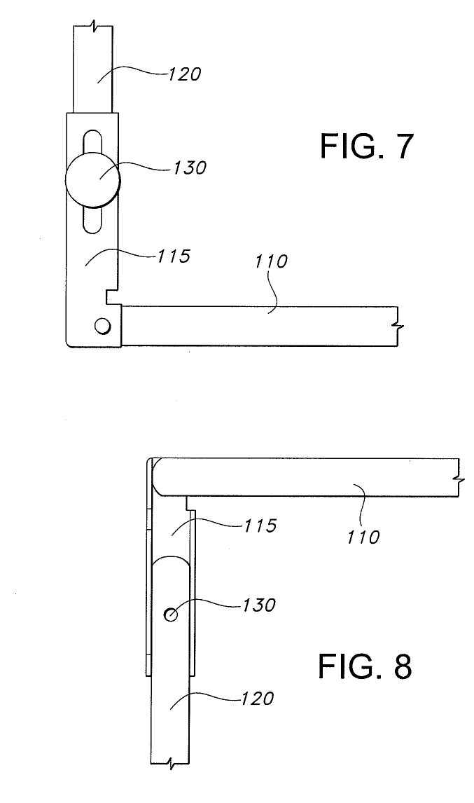

Referring now to FIGS. 6-8, the proximal end “P” of a mounting bracket 120 is depicted situated within the grooved region of a mounting flange 15. The mounting bracket 120 and flange 115 are aligned along the translational axis “A_{T}”. More particularly, the proximal end “P” of the mounting bracket 120 may slide within the grooved region of the flange 115 along the translational axis “A_{T}”. As previously discussed, a hole 120A may be defined through the proximal end “P” of the mounting bracket 120, wherein said hole 120A may be aligned with a portion of the slot region 115A in the mounting flange 115. The hole 120A is generally configured to receive a fastener, e.g., a screw 130 therein (see FIGS. 7 and 8). Note that the hole 120A may be advantageously threaded for association with the screw 130. Typically, the screw 130 is inserted through the slot region 115A and secured relative to the mounting bracket via interaction with hole 120A. Thus, the screw 130 may cooperate with the slot 115A to effect the translational relationship between the mounting bracket 120 and the flange 115.

The translational relationship between the mounting bracket 120 and the flange 115 advantageously allows a user to adjust the position of the support member 110 relative to the mounting bracket 120 (along the translational axis “A_{T}”). Once an optimal/desired position is achieved, the mounting bracket and support member 110 may be optionally secured relative to one another by tightening the screw 130. The screw 130 may also be removed to detach the support member 110 from the mounting bracket 120. By detaching the support member 110, a user is able to gain unobstructed access to equipment, e.g., patch panels, that may have otherwise been obstructed by the support member 110. Note that this means of detaching the support member 110 is far less cumbersome than having to detach the mounting brackets, e.g., from a cabinet enclosure.

Referring now to FIG. 9, an advantageous swiveling cable management clip 200 for association with a cable management bar, e.g., cable management bar 100, is depicted. In general, the cable management clip 200 includes a top element 210, a bottom element 220, and a shaft 230. The top element 210 may define one or more conduits/channels, e.g., channel 215, for receipt of one or more patch cables (not depicted) therethrough. The bottom element may include a clasp mechanism 225 for securing said cable management clip 200 relative to a cable management bar. Referring now to FIG. 2, the clasp mechanism 225 may be used to secure the cable management clip 200 relative to the support member 110 of the cable management bar 100. In exemplary embodiments, the cable management clip 200 may be translationally related relative to the support member 110 of the cable management bar 100. Thus, a user may slide the cable management clip 200 along the length of the support member 110 to a desired/optimal position.

Referring again to FIG. 9, the top element 210 is typically rotationally related relative to the bottom element 220 along a swivel axis “A_{S}”. Thus, the top element 210 and bottom element 220 may define apertures 210A and 220A for receipt of the shaft 230. In exemplary embodiments, the bottom face of the top element 210 may define a plurality of notches 210B. Similarly, the top face of the bottom element 220 may define a plurality of teeth 220B. When the top element 210 and bottom element 220 are in contact, thereby defining a detent mechanism, the notches 210B and teeth 220B may cooperate to prevent the top element 210 from rotating relative to the bottom element 220. Thus, a user may lift the top element 210 slightly along the swivel axis “As”, rotate the top element 210 to a desired/optimal orientation, and lower the top element 210 into contact with the bottom 220 element so as to secure the desired/optimal orientation. Alternatively, an appropriate force to overcome the detent mechanism may be applied so as to cause a desired level of rotation. Note that in further exemplary embodiments, a ratchet configuration may be employed instead of the notches 210B and teeth 220B. The ratchet configuration may be used to prevent rotation in a single direction and may be appropriate, e.g., to facilitate using the cable management clip 200 as a spool.

Of note, the disclosed cable management bar and the disclosed swiveling cable management clip may be employed independently or in combination, as desired by a manufacturer and/or end user.

Although the present disclosure has been described with reference to exemplary embodiments and implementations thereof, the disclosed apparatus, systems and methods are not limited to such exemplary embodiments/implementations. Rather, as will be readily apparent to persons skilled in the art from the description provided herein, the disclosed apparatus, systems and methods are susceptible to modifications, alterations and enhancements without departing from the spirit or scope of the present disclosure. Accordingly, the present disclosure expressly encompasses such modification, alterations and enhancements within the scope hereof.

What is claimed:

1. An adjustable cable management system, comprising
(a) a cable management bar having a plurality of mounting brackets, a support member defining a plurality of mounting flanges for association with said mounting brackets, and a plurality of fasteners for effecting a translational relationship between the support member and the plurality of mounting brackets; and
(b) one or more cable management clips, each clip including a top element defining a channel for receipt of one or more cables, a bottom element having a clasp mechanism, and a shaft for rotationally relating the top element relative to the bottom element,
wherein each cable management clip is attached relative to the support member of the cable management bar by means of the clasp mechanism.

2. The adjustable cable management system of claim 1, wherein to effect the translational relationship between the support member and the plurality of mounting brackets, the fasteners are inserted through slots defined by the mounting flanges and received by holes defined in the mounting brackets.

3. The adjustable cable management system of claim 2, wherein the fasteners are screws and the holes are threaded for association therewith.

4. The adjustable cable management system of claim 3, wherein the screws may be (i) loosened to effect the translational relationship between the support member and the mounting brackets and (ii) tightened to secure the support member relative to the mounting brackets.

5. The adjustable cable management system of claim 2, wherein the fasteners may be removed to detach the support member from the mounting brackets.

6. The adjustable cable management system of claim 1, wherein the each of the plurality of mounting flanges includes side walls defining a grooved region for receipt of a proximal end of one of the mounting brackets therein.

7. The adjustable cable management system of claim 1, wherein each of the plurality of mounting brackets are L-shaped, defining a mounting surface at a distal end for securing the mounting bracket relative to a cabinet enclosure of a patching system.

8. The adjustable cable management system of claim 7, wherein the cable management bar may be adjusted to effect a desirable bend radius for the cables of the patching system.

9. The adjustable cable management system of claim 1, wherein a bottom face of the top element and a top face of the bottom element define a plurality of teeth and notches, whereby the top element is substantially prevented from rotating relative to the bottom element when the top face and bottom face are in contact with one another.

10. The adjustable cable management system of claim 9, wherein the top element may be rotated relative to the bottom element by lifting the top element along the shaft, such that the top face and bottom face are no longer in abutting contact with one another.

11. The adjustable cable management system of claim 1, wherein the top element and bottom element are related by means a ratchet mechanism, the ratchet mechanism effecting the rotational relationship by preventing relative rotation between the top element and bottom in a single direction.

12. The adjustable cable management system of claim 1, wherein the clasp means effects a translational relationship between the cable management bar and each of the cable management clips.

13. An adjustable cable management bar, comprising
(a) a plurality of mounting brackets;
(b) a support member defining a plurality of mounting flanges for association with said mounting brackets; and
(c) a plurality of fasteners for effecting a translational relationship between the support member and the plurality of mounting brackets.

14. The adjustable cable management bar of claim 13, wherein to effect the translational relationship between the support member and the plurality of mounting brackets, the fasteners are inserted through slots defined by the mounting flanges and received by holes defined in the mounting brackets.

15. A swiveling cable management clip comprising
(a) a top element defining a channel for receipt of one or more cables;
(b) a bottom element having a clasp mechanism for securing the cable management clip relative to a cable management bar; and
(c) a shaft for rotationally relating the top element relative to the bottom element.

16. The swiveling cable management clip of claim 15, wherein a bottom face of the top element and a top face of the bottom element define a plurality of teeth and notches, whereby the top element is prevented from rotating relative to the bottom element when the top face and bottom face are in contact with one another.

17. The swiveling cable management system of claim 16, wherein the top element may be rotated relative to the bottom element by lifting the top element slightly along the shaft, such that the top face and bottom face are no longer in contact with one another.

18. The swiveling cable management system of claim 15, wherein the top element and bottom element are related by means a ratchet mechanism, the ratchet mechanism effecting the rotational relationship by preventing relative rotation between the top element and bottom in a single direction.

19. The adjustable cable management system of claim 15, wherein the clasp means effects a translational relationship between the cable management bar and each of the cable management clips.

20. A method for facilitating cable management comprising
(a) providing an adjustable cable management bar, including
i. a plurality of mounting brackets, mounted relative one or more patch panels; and
ii. a cable support member detachably associated relative to the mounting brackets and obstructing or partially obstructing access to the one or more patch panels;
(b) detaching the adjustable cable management bar from the mounting brackets and removing the cable management bar, such that the cable management bar ceases to obstruct or partially obstruct access to the one or more patch panels;
(c) making any desired cabling changes relative to the one or more patch panels; and
(d) reattaching the support member relative to the mounting brackets after the any desired cabling changes are complete.
